(19) United States
(12) Patent Application Publication
(10) Pub. No.: US 2016/0135079 A1
(43) Pub. Date: May 12, 2016

(54) IP Media Rate Adaptation

(71) Applicant: TELEFONAKTIEBOLAGET L M ERISSON (PUBL), Stockholm (SE)

(72) Inventors: Per Synnergren, Gammelstad (SE); Lennart Norell, Alvsjo (SE)

(21) Appl. No.: 14/897,572

(22) PCT Filed: Jun. 12, 2013
(86) PCT No.: PCT/SE2013/050683

§ 371 Date: Dec. 10, 2015

(51) Int. Cl. H04W 28/02

(52) U.S. Cl. CPC H04W 28/0289

(57) ABSTRACT

A method of managing congestion in a packet switched access network. The method is performed within a packet core network providing a transit network for a user media stream sent from a sending device via the packet switched access network. Actual or potential congestion in the packet switched access network associated with said user media stream is identified. In response to such identification, the sending device is notified of the actual or potential congestion by inserting a notification of congestion into control signalling of the media stream.

### FIELD OF THE INVENTION

The present invention relates to IP media rate adaptation in respect of end-users in radio access networks.

### BACKGROUND

3GPP standards specify Radio Access Network architectures and functionality to allow end-users to access mobile network services. In particular, 3GPP specifies an architecture and functionality that allows users to access high speed and high bandwidth uplink and downlink data services. However, the radio environment for an end-user will inevitably vary due to, for example, the movement of the user and the served load in the cell currently serving the end-user and in other neighbouring cells. This results in the served bit rate to the end-user also varying. This is particularly problematic for the uplink direction which typically has a lower bandwidth than the downlink direction. To address the problems caused by a fluctuating served bit rate for the end-user in question, and for other users and the network, it is desirable to allow for dynamic adaptation of the media bit rate.

For most IP services, the bit rate of transmitted media is controlled by the sender of the media, generally with feedback from the receiver of the media. For example, a common implementation of bit rate control is monitoring packet losses at the receiver, and communicating the packet losses to the sender. If the packet losses reach an unacceptable value, the sender can reduce the bit rate of the transmission to compensate. The main problem with such solutions is that the adaptation of the bit rate occurs after the connection problems have occurred, and the packet losses may have already caused delays or a significant reduction in service quality.

Explicit Congestion Notification (ECN) was developed to allow the transport infrastructure to be part of the congestion handling solution. The basic principle, as shown in FIG. 1, is that equipment on the path taken by the packets, such as routers, which start to experience rising congestion can set an “ECN bit” on packets passing through the equipment before the congestion reaches a level where service is unacceptably affected. The ECN bit is received by the receiving device 202, which then notifies the sending device 201. This allows the sending device 201 to adapt its sending rate such that packet loss is avoided rather than reacting when packet loss starts to appear. If the receiving device 202 does not support ECN, then it will not notify the sending device 201 that the ECN bit has been received, and so the sending device 201 will not adjust the sending rate until a reduced quality of service (e.g. packet loss) occurs.

ECN was first defined for TCP/IP traffic. In the TCP/IP implementation, the ECN bit values set by the transport infrastructure are detected by the receiving device 202. The receiving device then includes a congestion notification in the TCP ACK message returned to the sending device 201. In this way, the sending device 201 is notified about the congestion, and can modify the transmission accordingly.

Real-time media, for example voice calls, video calls, and video streaming, is commonly sent using the RTP (Real-time Transport Protocol)/UDP/IP protocol suite. ECN has been defined for this protocol suite in IETF RFC 6679. ECN is particularly useful in this implementation as the media stream is typically so sensitive to delays that it is not possible to wait for packets to be resent. Packet loss is especially detrimental to media streams, as a single lost packet containing an I-frame in an MPEG stream will cause the picture to become garbled until a new I-frame is transmitted.

In the RTP/UDP/IP implementation of ECN, the ECN bits are set by the transport infrastructure in the packet header in a similar way as in the TCP/IP implementation. The primary difference is that the acknowledgement to the sender is done using RTCP (RTP Control Protocol) packets. Unfortunately, the ECN specification for RTP/UDP/IP was defined late, and as such it is not widely supported in user terminals.

The 3GPP specification 3GPP TS 26.114 specified the use of ECN for RTP/UDP, but only in the isolated case of multimedia telephony over mobile broadband networks, and only as an optional function. As such, this is also not widely supported. The solution is substantially the same as the solution specified by the IETF.

There is therefore a need to provide a solution for congestion control which does not depend on the sending and receiving end points having specific functionality.

### SUMMARY

According to a first aspect of the present invention, there is provided a method of managing congestion in a packet switched access network. The method is performed within a packet core network providing a transit network for a user media stream sent from a sending device via the packet switched access network. Actual or potential congestion in the packet switched access network associated with said user media stream is identified. In response to such identification, the sending device is notified of the actual or potential congestion by inserting a notification of congestion into control signalling of the media stream.

According to a second aspect of the present invention, there is provided an apparatus configured to act as a node configured to manage congestion in a packet switched access network. The apparatus comprises a congestion detector and a rate controller. The congestion detector is configured to identify actual or potential congestion in the packet switched access network associated with said user media stream sent from a sending device via the packet switched access network. The rate controller comprises a control signalling receiver, a signalling modifier, and a control signalling sender. The control signalling receiver is for receiving the control signalling of the media stream. The signalling modifier is for modifying the signalling to include a notification of congestion in response to the congestion detector identifying actual or potential congestion. The control signalling sender is for sending the modified signalling towards the sending device.

According to a third aspect, there is provided a computer program comprising computer readable code which, when run on an apparatus, causes it to behave as an apparatus according to the second aspect. The computer program may be stored in a computer program product comprising a non-transitory computer readable medium.

### BRIEF DESCRIPTION OF THE DRAWINGS

FIG. 1 illustrates the basic functioning of the ECN system;

FIG. 2 illustrates an example network structure according to an embodiment;

FIG. 3 illustrates schematically a Rate Adaptation Control Function according to an embodiment;

FIG. 4 illustrates schematically a Rate Adaptation Control Function according to an embodiment;

FIG. 5 is a flowchart showing a method according to an embodiment; and

FIG. 6 illustrates possible nodes for implementation of the Rate Adaptation Control Function.

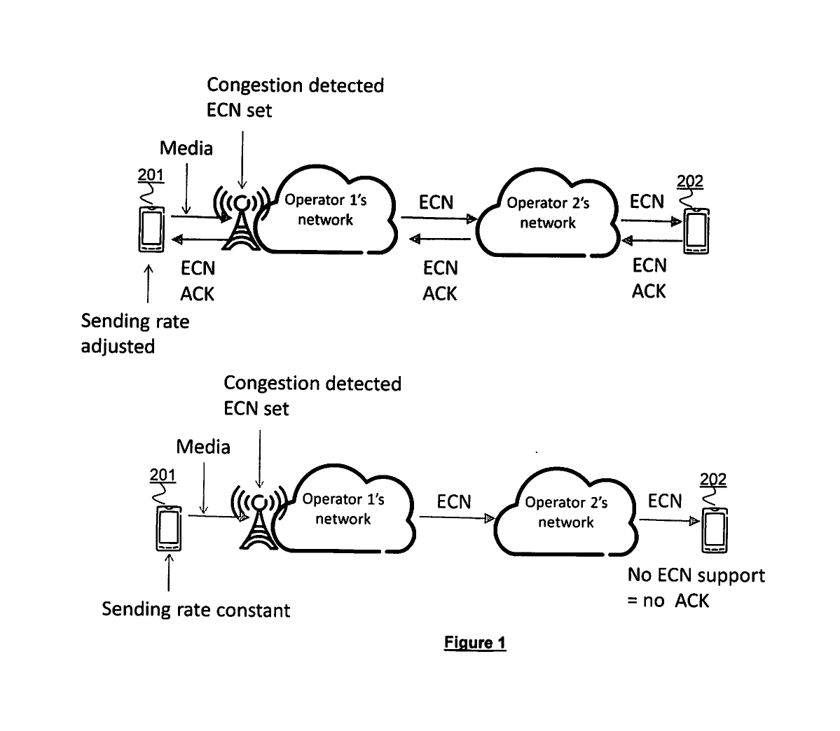

### DETAILED DESCRIPTION

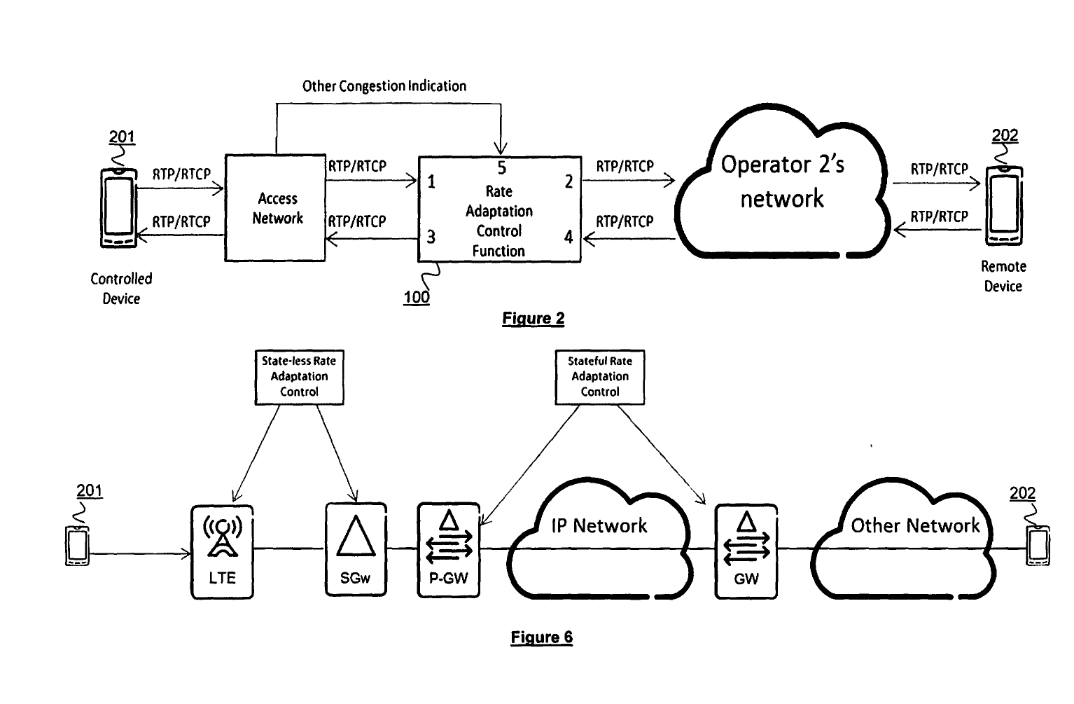

FIG. 2 shows an example network structure according to an embodiment. A new Rate Adaptation Control Function (RACF) 100 is added into operator 1's network. The RACF 100 receives information about the current congestion in the network 5, and then indicates to the sending device 201, based on certain rules, how the sending rate should be adjusted. The RACF 100 is positioned in the path of the packets of the media stream and the control stream (1 to 2 and 4 to 3) so that it can provide indications to the sending device 201 by modifying the packets of the control stream. The RACF 100 may also monitor the packets of the media stream, e.g. to determine the bit rate of the stream or to check for ECN bits. The indications to the sending device 201 can either be explicit about the reduction in sending rate required, or send an indication of the level of congestion, e.g. how many packets with ECN bits have passed through the RACF 100.

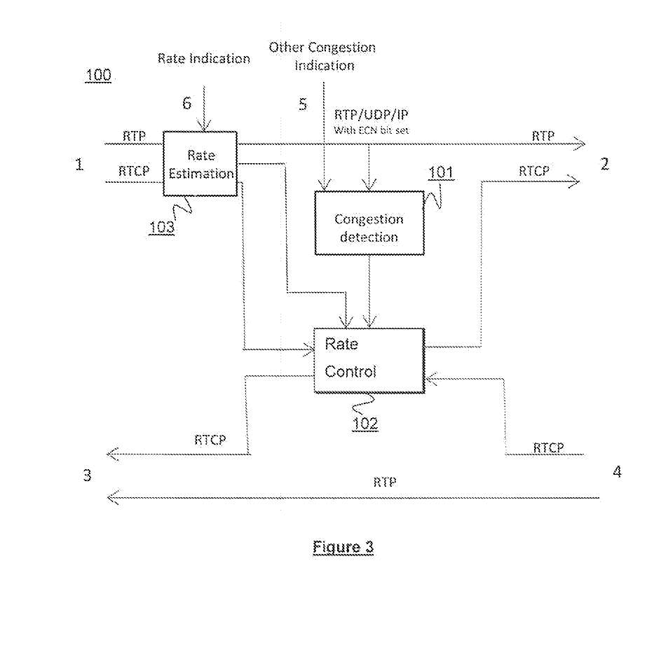

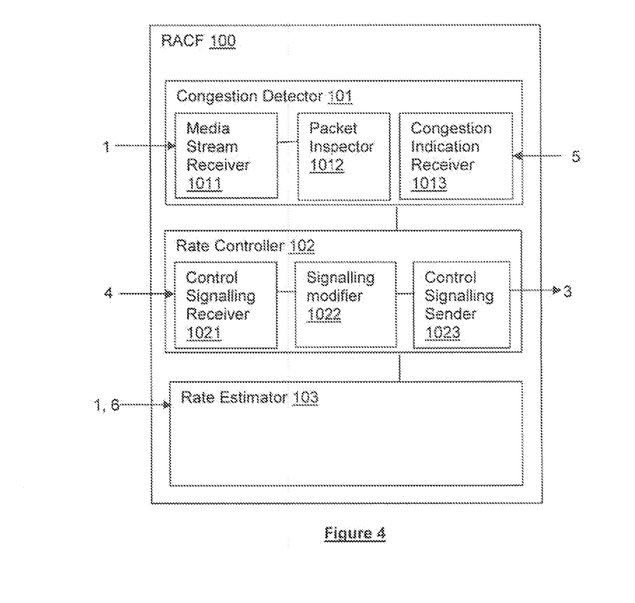

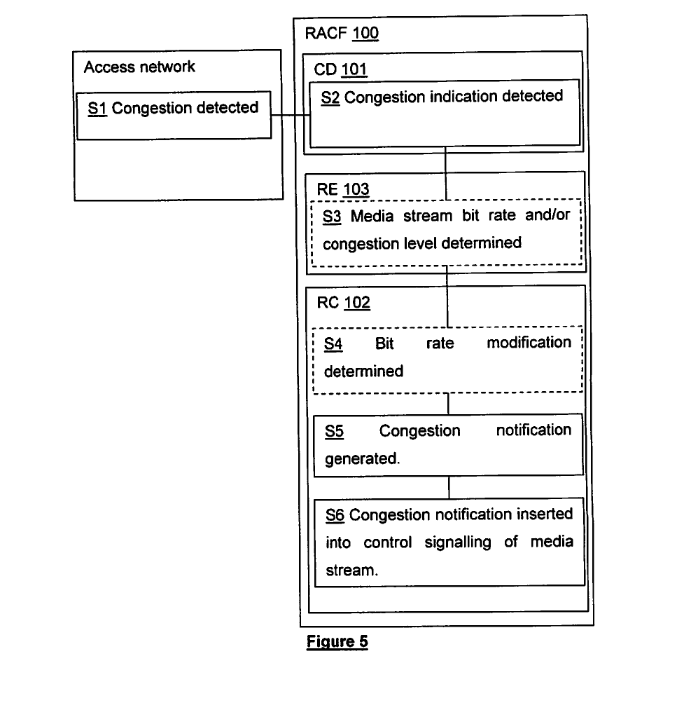

The structure of the RACF 100 is shown in FIGS. 3 and 4, and its operation is shown in FIG. 5. The RACF 100 comprises a Congestion Detector (CD) 101 and a Rate Controller (RC) 102. The RACF 100 may also comprise a Rate Estimator (RE) 103. RTP packets sent between the sending device 201 and the receiving device 202 flow past or through the RACF 100 unmodified, while RTCP packets are routed via the RC 102 so that the RC 102 may add, modify or remove packets.

The access network sends notifications of congestion S1 which are then received S2 by the CD 101. These indications may include ECN bits in the RTP/UDP/IP messages, or some other indication communicated to the CD 101 by the RTP media stream 1 or some other means 5. The congestion indications may be in the packet stream, in which case the CD 101 comprises a media stream receiver 1011 and a packet inspector 1012, or they may be sent separately, in which case the CD 101 comprises a congestion indication receiver 1013. If congestion is detected, then the CD 101 triggers the RC 102, which adds or modifies an RTCP message towards the sending device 201, to cause it to reduce the sending rate. The RC 102 comprises a control signalling receiver 1021 for receiving the control signalling of the media stream, a signalling modifier 1022 for modifying the control signalling to cause the sending device to reduce the sending rate S5, and a control signalling sender 1023 to send the modified signalling to the sending device S6.

The RTCP message used may include:
Sender report/Receiver report (SR/RR)
Extended Report (ER)
ECN Feedback Message
Temporary Maximum Media Stream Bit Rate Request (TMMBR) [As described in 3GPP TS 26.114]
Application-defined RTCP packet (RTCP APP) containing codec control requests and/or media rate requests.

In the case where the RC 102 sends a TMMBR or RTCP APP message, the required bit rate and/or codec will be indicated in the message. The RE 103 may be used to monitor the bit rate and/or codec used for the RTP media stream S3, which can be communicated to the RC 102 to allow the RC 102 to determine the bit rate and/or codec which should be used to reduce the congestion in the access network S4. The required bit rate and/or codec may also be based on internal policies and/or congestion information from the CD 101.

The TMMBR message is described in 3GPP TS 26.114. This message must be understood by all mobile telephones implementing video calling over an LTE or HSPA radio access network, as required by GSMA PRD IR.94 v5.0 “IMS Profile for Conversational Video Service”. The message would normally be sent by the receiving device when packet loss and/or congestion are detected. Where a TMMBR message is used, the sending device 201 will respond with a Temporary Maximum Media Stream Bit Rate Notification (TMMBN) message. The RC 102 may be configured not to forward this message to the receiving device.

If the sending device has support for ECN, then the RC 102 may send the ECN feedback messages as described in the background. In this case, the RC 102 does not indicate a required bit rate and/or codec; it only informs the sending device 201 how many ECN marked packets have been detected by the CD 101. Alternatively, the CD 101 may be informed of congestion in the access network without the access network setting ECN bits, in which case the RC 102 may respond as if packets sent during the congestion had been marked with ECN bits.

The RC 102 may instead use the ordinary SR/RR RTCP messages to indicate the congestion situation. These messages do not contain ECN feedback, but the RC 102 may insert messages which indicate packets have been lost so that rate control is triggered on the sending device. These messages may be inserted even if there are in fact no lost packets, to ensure that rate control is triggered before the congestion begins to reduce quality of service. This information may be added to SR/RR messages which are sent from the receiving device.

The CD 101 may detect congestion in multiple ways. The CD 101 could detect ECN bits on packets travelling through the network. Alternatively, the CD 101 could have an interface 5 to the access network, through which the access network informs the CD 101 of the current load/congestion level, or of an allowed rate for a certain service. The allowed rate could be either a total rate, a required reduction in the bit rate, or a percentage of the current rate.

The CD 101 may subscribe to updates from the access network over the interface 5. Alternatively, the CD 101 may request a congestion indication based on some internal trigger. This trigger may be a sudden drop in packet throughput, packet losses, and/or regular updates.

If the CD 101 is informed of the current congestion level, then the RC 102 requires logic to compute an allowed rate (in the case where the RC 102 reports by TMMBR or RTCP APP) or the congestion level to report to the sending device (in the case where the RC 102 reports by ECN feedback message, SR or RR). This computation may take into account the current bit rate or codec in use for the session (as reported by the RE 103). The RE 103 may obtain this information from the control plane (e.g. from the SDP in the session negotiation). The rate can also be estimated by measuring it in the RTP user plane flow 1-2 or by the context in the RTCP Sender Reports for the session.

The RACF may be implemented as either a stateless RACF or a stateful RACF.

A stateless RACF would not keep a state for the RTP sessions passing through the RACF, but only act on a specific congestion trigger. The stateless RACF is therefore unaware of the current rate, and so can only inform the sender of congestion, or suggest a relative reduction in rate. For example, the stateless RACF may be configured to send an RTCP SR/RR indicating packet loss to the sender (as described above) in response to detecting ECN bits in RTP packets for a session. As a further example, the RACF may be configured to send an RTCP APP packet indicating a percentage bit rate reduction required for a specific service in response to the access network indicating congestion.

If the stateless RACF is informed of the current bit rate (or codec mode), for example by an interface to the control pane of the access network, then it can calculate the required bit rate and use a TMMBR or RTCP APP message to communicate this to the sending device.

The stateful RACF can measure the bit rate itself, and therefore use any of the response messages indicated above. However, since the stateful RACF is required to keep a state for the session, it should either be placed above the mobility anchor point, or protocols must be put in place to transfer the state to another RACF in case of a handover.

The RACF 100 may be implemented as a stand-alone node, which is in the path taken by the packets of the media stream. The CD 101, RC 102 and RE 103 of the RACF 100 may be implemented in different nodes. Alternatively, the RACF 100 may be integrated with existing nodes of the mobile network. This may be a node on the path of the packets sent from the sending device (other than the sending 201 or receiving 202 device). Examples of nodes in which the RACF may be implemented are shown in FIG. 6. For a stateful RACF, possible nodes include the P-GW or border control gateway. For a stateless RACF (or a stateful RACF with handover protocols implemented), possible nodes include those for the stateful RACF, as well as the S-GW or basestation, NodeB or eNodeB.

If the CD 101, RC 102, and RE 103 are implemented in different nodes, the RC 102 has the same restrictions as the single-node RACF above, the CD 101 and RE 103 may be implemented anywhere provided that the RE 103 can monitor the packets of the media stream, and the CD 101 can communicate with the access network and/or monitor the packets or copies of the packets.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1-21. (canceled)

22. A method of managing congestion in a packet switched access network, the method comprising carrying out the following steps within a packet core network providing a transit network for a user media stream sent from a sending device via the packet switched access network:
identifying actual or potential congestion in the packet switched access network associated with said user media stream; and
in response to such detection, notifying the sending device of the actual or potential congestion by inserting a notification of congestion into control signaling of the media stream.

23. The method of claim 22, wherein said step of identifying comprises detecting congestion indicators in the content of the media stream.

24. The method of claim 23, wherein the congestion indicators comprise an Explicit Congestion Notification (ECN) bit.

25. The method of claim 22, wherein detecting congestion indicators relating to the user media stream comprises receiving congestion indicators from a node or nodes in the packet switched access network

26. The method of claim 22, wherein the media stream comprises Real-time Transport Protocol (RTP) packets and the control signaling of the media stream comprises RTP Control protocol (RTCP) packets.

27. The method of claim 22, wherein the notification of congestion comprises any of:
an Explicit Congestion Notification (ECN) feedback packet;
a notification of packet loss;
an RTCP sender report (SR);
and an RTCP receiver report (RR).

28. The method of claim 22, further comprising, within the packet core network:
determining one of a level of congestion or a bit rate of the media stream; and
calculating a required bit rate modification for the media stream from the level of congestion or the bit rate of the media stream;
wherein the notification of congestion comprises the required bit rate modification.

29. The method of claim 28, wherein the required bit rate modification is any one of:
a percentage of the bit rate of the media stream;
a required future bit rate of the media stream;
a difference between the required future bit rate and the bit rate of the media stream; and
a required mode of a codec of the media stream.

30. The method of claim 22, wherein the notification of congestion is a Temporary Maximum Media Stream Bit Rate Request (TMMBR) or application-defined RTCP packet (RTCP APP).

31. An apparatus configured to act as a node in a packet core network providing a transit network for a user media stream sent from a sending device via the packet switched access network, the node being configured to manage congestion in a packet switched access network, the apparatus comprising:
a congestion detector configured to identify actual or potential congestion in the packet switched access network associated with said user media stream sent from a sending device via the packet switched access network; and
a rate controller comprising
a control signaling receiver for receiving the control signaling of the media stream,
a signaling modifier for modifying the signaling to include a notification of congestion in response to the congestion detector identifying actual or potential congestion; and
a control signaling sender for sending the modified signaling towards the sending device.

32. The apparatus of claim 31, wherein the congestion detector comprises:
a media stream receiver for receiving packets of the media stream;
a packet inspector for inspecting the packets for congestion indicators.

33. The apparatus of claim 31, wherein the congestion detector comprises a congestion indication receiver for receiving congestion indications from a node in the access network.

34. The apparatus of claim 31, wherein the media stream comprises Real-time Transport Protocol (RTP) packets and the control signaling of the media stream comprises RTP Control Protocol (RTCP) packets.

35. The apparatus of claim 31, wherein the notification of congestion comprises any of:
an Explicit Congestion Notification (ECN) feedback packet;
a notification of packet loss;
an RTCP sender report (SR);
and an RTCP receiver report (RR).

36. The apparatus of claim 31, further comprising:
a rate estimator configured to determine a bit rate of the media stream; wherein the signaling modifier is further configured to calculate a required bit rate
modification for the media stream from the bit rate of the media stream; wherein the notification of congestion comprises the required bit rate modification.

37. The apparatus of claim 36, wherein the required bit rate modification is any one of:
a percentage of the bit rate of the media stream;
a required future bit rate of the media stream;
a difference between the required future bit rate and the bit rate of the media stream;
a required mode of a codec of the media stream.

38. The apparatus of claim 31, wherein the signaling modifier is further configured to calculate a required bit rate modification for the media stream from a congestion level of the media stream, and the notification of congestion comprises the required bit rate modification.

39. The apparatus of claim 31, wherein the notification of congestion is a Temporary Maximum Media Stream Bit Rate Request (TMMBR) or application-defined RTCP packet (RTCP APP).

40. The apparatus of claim 31, wherein the apparatus is further configured to act as any one of:
a basestation;
a NodeB or eNodeB;
a serving gateway (SGW);
a Public Date Network gateway (PGW); and
a border control gateway.

41. A non-transitory computer-readable comprising, stored thereupon, a computer program comprising computer readable code that, when run on an apparatus configured to act as a node in a packet core network providing a transit network for a user media stream sent from a sending device via the packet switched access network, the node being configured to manage congestion in a packet switched access network apparatus, causes the apparatus to:
identify actual or potential congestion in the packet switched access network associated with said user media stream; and
notify the sending device of the actual or potential congestion, in response to such detection, by inserting a notification of congestion into control signaling of the media stream.
